(19) United States
(12) Patent Application Publication
(10) Pub. No.: US 2017/0042133 A1
(43) Pub. Date: Feb. 16, 2017

(54) Fish Landing Net

(71) Applicant: Ryan C Rasmussen, San Tan Valley, AZ (US)

(72) Inventor: Ryan C Rasmussen, San Tan Valley, AZ (US)

(21) Appl. No.: 15/156,706

(22) Filed: May 17, 2016

Related U.S. Application Data
(60) Provisional application No. 62/165,095, filed on May 21, 2015.

(51) Int. Cl. A01K 77/00

(52) U.S. Cl. CPC A01K 77/00

(57) ABSTRACT

A handheld landing net hoop shape that positions greater landing net hoop opening in the area an angler first pulls a hooked fish into a landing net. One side of the hoop shape follows a more customary teardrop shape while the other side of the hoop shape extends further and at an angle that complements the natural reach of an angler as he prepares to scoop a hooked fish. It is an efficient use of landing net hoop circumference for the angler who is catching a fish with the aid of a handheld landing net.

### FIELD OF THE INVENTION

The present invention relates generally to equipment and accessories used by anglers in the sport of fishing. More particularly, it relates to landing nets that are of the type used by anglers to assist them with catching fish.

### BACKGROUND OF THE INVENTION

To increase their chances for successful fishing, anglers utilize equipment and accessories that will aid in catching fish. The landing net is one piece of equipment that anglers have used for many years to help reduce the load that is otherwise placed on the angler's hook and on the line that is connected to it when pulling a fish toward the angler, thereby also reducing the risk of losing the hooked fish. It also aids the angler in landing the fish more quickly. More recently, modern anglers opt for the release of the caught fish, the idea being that the fish can recover and be recaught at another time. This catch and release practice of fishing tends to look for ways to decrease the trauma inflicted on the fish while being caught and thereby increasing the likelihood of survival of the released fish. By decreasing the amount of time to land the hooked fish the degree of exhaustion decreases and the likelihood of fish recovery and survival increases. When a landing net is used, fish tend to be caught more quickly. In the view of this inventor, however, there is room for improvement of the traditional landing net, particularly in light of the fact that landing nets have not changed very much over time and certainly not in step with the modern acceptance and goals of catch and release fishing. Some landing nets try to achieve an increase in effectiveness by utilizing a longer handle and or a larger hoop opening thereby making it easier and quicker to get the fish in the net. While these landing net changes can help there are practical limitations to increases in handheld landing net size. In fact, some anglers cite the cumbersome aspect of carrying landing nets as a reason they don't use them at all or less frequently than they would like to.

### SUMMARY OF THE INVENTION

The asymmetric hoop shape of the present invention has obtained these objects. The asymmetric shape of the present invention provides for a landing net hoop opening that is proportioned in such a way as to purposefully place more hoop area in the place that the hooked fish initially enters the net in relation to the angler. In consideration of the position of the angler to the approaching hooked fish, greater landing net hoop efficiency can be achieved with the present invention than with the current landing net hoop shapes. The foregoing and other features of the present invention will be apparent from the detailed description that follows.

### BRIEF DESCRIPTION OF THE DRAWINGS

FIG. 1 is a plan view of the present invention;

FIG. 2 is a front, top and right side perspective view of FIG. 1;

FIG. 3 is a view of how a user may hold the landing net of FIG. 1;

### DETAILED DESCRIPTION OF THE INVENTION

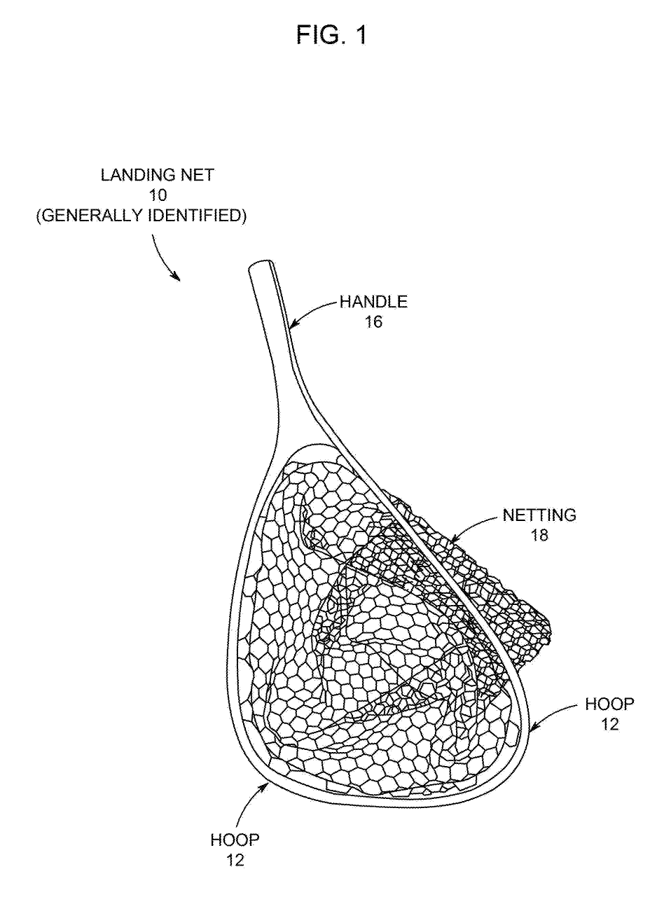

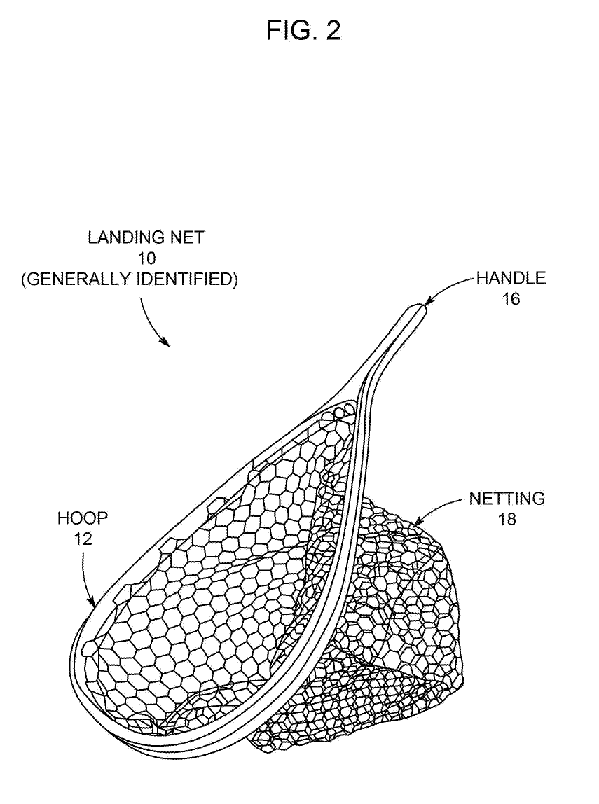

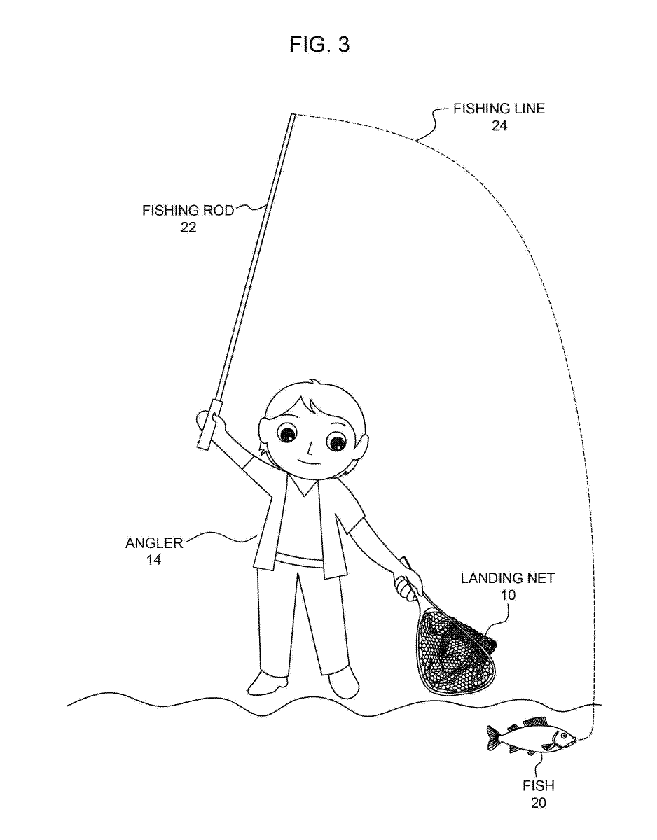

Referring now to the drawings in detail, wherein like numbers represent like elements throughout, FIGS. 1 and 2 illustrate two different perspective views of a landing net 10, generally identified, that uses the preferred embodiment of a hoop 12 constructed in accordance with the present invention. FIGS. 1 and 3 illustrate the asymmetric shape of the hoop 12. The asymmetric hoop 12 shape is shown to extend the hoop 12 opening on the right side of the hoop 12 while the left side of the hoop 12 follows a more traditional shape. FIG. 3 illustrates the landing net 10 as it may be used by an angler 14 and shows the advantage of the asymmetric hoop 12 shape.

As shown, the landing net 10 assembly includes a handle 16, the hoop 12 connected together and a net 18 attached thereto. The handle 16 and the hoop 12 can be constructed of many various materials including, but not limited to wood, metal, composites, thermoplastics and so forth. The net 18 can also be made of various materials such as, but not limited to, nylon mesh, knotted string, rubberized materials and so forth. The hoop 12 being asymmetric in its circumference with one side of the hoop 12 shape following a more traditional shape starting from the hoop 12 connection at the handle 16 and traveling the circumference of the hoop 12 until at the point where a traditional shape typically would return to the handle 16 in a symmetric pattern, but instead continues more laterally until finally making a tighter radius and continuing in a more direct path back to the handle 16. This arrangement places the most wide aspect of the hoop 12 opening lower down the hoop and further away from the angler holding the landing net thus creating a more advantageous area to catch or scoop the fish 20.

In more detail, still referring to FIG. 3, in its' most basic functionality, the landing net 10 is extended in the hand of the angler 14 toward a fish 20 being caught. Often, the position of the hooked fish 20 relative to the angler 14 is slightly opposite from the side the angler 14 is holding a fishing rod 22. Because of this common position of the angler 14 to the hooked fish 20, the use of the asymmetric hoop 12, of the present invention, provides the angler 14 a greater hoop 12 opening in the area the hooked fish 20 first enters the landing net 10 over symmetrical hoop shapes of the same circumference and handle length. The hoop 12 of the present invention is not constrained by a specific circumference or handle 16 length.

In more detail, still referring to the invention of FIG. 3, As the angler 14 reaches to scoop the hooked fish 20 with the landing net 10 in his outstretched hand, the hoop 12 shape of the present invention will provide that the most wide portion of the hoop 12 opening will be generally parallel with the water line and in a optimal location to scoop the hooked fish 20. This placement of hoop 12 opening will give the angler 14 a greater hoop 12 opening area to scoop the hooked fish 20 into the landing net 10. The landing net 10 is shown in a left hand position of the angler 14 and the asymmetry of the hoop 12 places more hoop 12 opening away from the body of the angler 14 effectively extending the reach of the landing net 10 over a net of traditional shape.

In more detail, still referring to the invention of FIG. 1 and FIG. 2 and FIG. 3, the asymmetric hoop 12 shape can be utilized in more than one position and in the right hand, left hand or both hands by simply rotating the landing net 10. The landing net need not only be held by the angler 14 as shown. For example, the landing net 10 of the present invention can be rotated in the hand(s) of the angler 14 so that the most reaching aspect of the hoop 12 is pointed down deeper into the water instead of away from the angler 14. The idea being that an asymmetric hoop 12 shape allows for various uses of the same landing net 10 because it offers the angler 14 various hoop 12 aspects depending on how it is held.

In more detail, still referring to the invention of FIG. 1 and FIG. 2 and FIG. 3, the asymmetric aspect of the hoop 12, when held by the angler 14 as shown, places the wide portion of the hoop 12 further down in the hoop 12 opening thus placing the widest aspect of the hoop 12 in the area where the hooked fish 20 first enters the net. The shape of the asymmetric aspect of the hoop 12 can vary with changing conditions such as, but not limited to, water depth, fish 20 depth, and angler 14 height. The exact design of the present invention should not be considered the only asymmetric shape that will provide the ideal shape for all conditions. The asymmetric shape of the present invention is an example of one asymmetric configuration that can provide the benefits of increased landing net 10 performance and/or uses over symmetric landing nets. The asymmetric hoop 12 shape of the present invention could be adjustable and thus be optimised for varying conditions.

In more detail, still referring to the invention of FIG. 1 and FIG. 2 and FIG. 3, the advantages of moving the widest aspect of hoop 12 opening further down the hoop 12 and further away from the angler 14 can be achieved either in the right hand, left hand, or both hands by appropriately rotating the landing net 10 in the chosen hand(s).

The advantages of the present invention include, without limitation, a more efficient handheld landing net 10 hoop 12 shape for any given hoop 12 circumference.

In broad embodiment, the present invention is a landing net 10 of efficient asymmetric hoop 12 shape for common angler 14 holding positions when catching fish 20.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A handheld landing net, wherein the improvement comprises an asymmetric shape to the landing net hoop in its circumference.

2. The improvement of claim 1, further comprising: the hoop being asymmetric in its circumference with one side of the hoop shape following a more traditional shape starting from the hoop connection at the handle and traveling the circumference of the hoop until at the point where a traditional shape typically would return to the handle in a symmetric pattern, but instead continues more laterally until finally making a tighter radius and continuing in a more direct path back to the handle. This arrangement places the most wide aspect of the hoop opening lower down the hoop opening and at a more optimised angle for the angler holding the landing net.

3. The improvement of claim 1, further comprising: the asymmetric shape of the hoop effectively extends the reach of a landing net and widens the area that a fish will initially enter the landing net over a net of the same handle length and same hoop circumference which does not have the asymmetric shape.

4. The improvement of claim 1, further comprising: any asymmetric shape in the circumference of the hoop of a handheld landing net which is meant to increase the effectiveness and or efficiently in the function of the landing net.
